(19) United States
(12) Patent Application Publication
(10) Pub. No.: US 2014/0120353 A1
(43) Pub. Date: May 1, 2014

(54) RADIATION-CURABLE POLYURETHANE DISPERSIONS

(71) Applicant: Bayer MaterialScience LLC, Pittsburgh, PA (US)

(72) Inventors: Richard R. Roesler, Pelican Rapids, MN (US); Lyubov K. Gindin, Pittsburgh, PA (US); Serkan Unal, Tuzla (TR); Peter D. Schmitt, Beaver, PA (US); Ronald M. Konitsney, Midland, PA (US)

(21) Appl. No.: 13/964,375

(22) Filed: Aug. 12, 2013

Related U.S. Application Data
(60) Provisional application No. 61/720,010, filed on Oct. 30, 2012.

(51) Int. Cl. C09D 175/08

(52) U.S. Cl. CPC C09D 175/08
USPC 428/423.1; 524/500; 522/86; 427/508; 427/496

(57) ABSTRACT

Curable aqueous polyurethane polymer dispersions are described. The dispersion comprises a polyurethane copolymer having pendant (meth)acrylate groups and pendant carboxylic groups along the main chain and a tertiary aminofunctional unsaturated monomer that has reacted in an acid/base reaction with the carboxylic acid groups on the main chain. The dispersion can be applied to the surface of a substrate and cured using ultra-violet or electron-beam radiation to form a cured polyurethane having desired properties that does not emit volatile amine compounds.

### FIELD OF THE TECHNOLOGY

The present disclosure relates to new radiation-curable aqueous anionic polyurethane dispersions that do not release volatile amine used as neutralizers. The amine neutralizers may be incorporated into the polymer backbone during the radiation curing process. Processes for forming the dispersions and films therefrom are also disclosed.

### BACKGROUND OF THE INVENTION

Aqueous dispersions of polyurethanes are commonly used in the production of polymeric coating and film compositions. These polyurethanes can possess desirable properties, such as, for example, chemical resistance, water resistance, solvent resistance, toughness, abrasion resistance, and durability.

Dispersibility of the polyurethane polymers into aqueous solution may be achieved by incorporation of ionic groups, such as cationic or anionic groups, or non-ionic hydrophilic groups into or pendant from the backbone of the polymer. The presence of ionic or hydrophilic groups increases the solubility of the polymer in the aqueous solvent. The functionality with the greatest dispersity enhancing effect is the carboxylic acid functional group. When carboxylic acid substitution is utilized, the acidic carboxylic functionality is typically neutralized with a volatile tertiary amine, either before or during dispersion of the polyurethane or polyurethane-polyacrylate in the aqueous solution. The tertiary amine forms an acid/base ionic pair with the carboxylate functionality.

The volatility of the tertiary amine neutralizing agent may present a problem since they can evaporate during film formation and are, therefore, a cause of environmental pollution. Thus, new hydrophilic polymeric compounds which avoid the used of volatile amine neutralizing agents are desired.

### BRIEF SUMMARY OF THE DESCRIPTION

The present disclosure provides for new aqueous anionic polyurethane dispersions that may be used for the formation of polymeric films and coatings. One embodiment of the present disclosure provides for an aqueous polymer dispersion comprising a polyurethane comprising a main chain and having pendant (meth)acrylate groups along the main chain and pendant carboxylic acid groups along the main chain; and a tertiary aminofunctional unsaturated monomer. The tertiary aminofunctional unsaturated monomer has a structure according to Formula I:

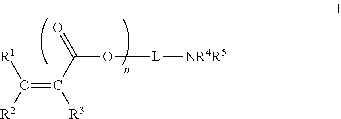

According to Formula I, R¹, R², and R³ are each independently H or straight or branched, substituted or unsubstituted C₁-C₁₀ alkyl, R⁴ and R⁵ are each independently organic groups which have no reactivity towards the carbon-carbon double bond or the amine functionality, n has a value of 0 or 1, and L is a divalent organic linking group.

Other embodiments of the present disclosure provide for a radiation-cured polyurethane comprising a reaction product of components comprising: a polyisocyanate monomer, a polyol monomer having a pendant carboxylic acid or carboxylate ion, a monomeric, oligomeric, or polymeric polyol unit having pendant (meth)acrylate groups, and a tertiary aminofunctional unsaturated monomer. According to these embodiments, the tertiary amine group of the tertiary aminofunctional unsaturated monomer has formed an ionic pair with a pendant carboxylic acid or carboxylate ion and an unsaturated group on the tertiary aminofunctional unsaturated monomer has reacted with a pendant (meth)acrylate group during a radiation-curing process. According to various embodiments, the tertiary aminofunctional unsaturated monomer has a structure according to Formula I, as described herein.

Still other embodiments of the present disclosure provide for a process for forming an aqueous polyurethane dispersion. The process comprises preparing a prepolymer comprising a polyurethane comprising a main chain and having pendant (meth)acrylate groups along the main chain and pendant carboxylic acid or carboxylate groups along the main chain, neutralizing the pendant carboxylic acid groups along the main chain with a tertiary aminofunctional unsaturated monomer, and dispersing the prepolymer in an aqueous solution.

Further embodiments of the present disclosure provide for a process for forming a radiation-cured polyurethane film. The process comprises: (a) applying a coating to at least a portion of a surface of a substrate to form a film; and (b) exposing the film to ultra-violet or electron beam radiation, wherein the coating comprises an aqueous polyurethane dispersion formed by a process comprising: (i) preparing a prepolymer comprising a polyurethane comprising a main chain and having pendant (meth)acrylate groups along the main chain and pendant carboxylic acid groups along the main chain, wherein the prepolymer is optionally in solvent; (ii) neutralizing the pendant carboxylic acid groups along the main chain with a tertiary aminofunctional unsaturated monomer; and (iii) dispersing the prepolymer in an aqueous solution to form a dispersion.

Coatings and films formed by the processes and polyurethane dispersions described herein are also disclosed.

### BRIEF DESCRIPTION OF THE FIGURES

The present disclosure should be read in conjunction with the following figures in which:

FIG. 1 illustrates a generalized structure of radiation curable polyurethane polymer dispersion according to the present disclosure

FIG. 2 illustrates the general structure of a non-crosslinked film FIG. 2A compared to a crosslinked film FIG. 2B.

### DETAILED DESCRIPTION OF THE INVENTION

Aqueous polymer dispersions of polyurethanes are useful, among other things, in coating compositions. Dispersibility of the polymer can be achieved by incorporation of ionic groups or non-ionic hydrophilic groups on the polymer backbone. Carboxylic acid functionality is one of the more common ionic functional groups. The carboxylic acid or other acidic functional group may be neutralized with a volatile tertiary amine before or during the dispersion process. Neutralization forms a carboxylate anion and a quaternary amine counterion. However, evaporation of residual volatile amine during or after film formation presents environmental issues. The present disclosure provides for polyurethane polymers suitable for aqueous dispersion formation, film formation, and other uses, where volatile amine evaporation is reduced or eliminated.

As used in this specification and the appended claims, the articles “a,” “an,” and “the” include plural referents unless expressly and unequivocally limited to one referent.

Additionally, for the purposes of this specification, unless otherwise indicated, all numbers expressing quantities of ingredients, reaction conditions, and other properties or parameters used in the specification are to be understood as being modified in all instances by the term “about,” Accordingly, unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

Further, while the numerical ranges and parameters setting forth the broad scope of the invention are approximations as discussed above, the numerical values set forth in the Examples section are reported as precisely as possible. It should be understood, however, that such numerical values inherently contain certain errors resulting from the measurement equipment and/or measurement technique.

The present disclosure describes several different features and aspects of the invention with reference to various exemplary embodiments. It is understood, however, that the invention embraces numerous alternative embodiments, which may be accomplished by combining any of the different features, aspects, and embodiments described herein in any combination that one of ordinary skill in the art would find useful.

Various embodiments of the present disclosure provide for polyurethane polymers where the polymer may be formed during a prepolymer formation step by reacting a diisocyanate with a (meth)acrylate bearing polyol. The prepolymer may be then chain extended using short chain dials or triols or diamines or polyamines. The final polymer may be dispersed in an aqueous medium and possesses active carbon-carbon double bonds available for cross-linking after film formation, for example, by exposure to ultra-violet (UV) or electron-beam (EB) radiation. The new polyurethane dispersions described herein combine the benefits of a one component waterborne system with the desirable performance of a two component waterborne system, including, for example, properties associated with cross-linking during film formation. Embodiments of the present disclosure provide processes for preparing dispersions of an anionic polyurethane that is more environmentally friendly than prior art radiation curable polyurethane dispersions. More environmentally friendly polyurethane dispersions are achieved by the use of a non-volatile tertiary amino-functional acrylic monomer or any other ethylenically unsaturated neutralizer that may be incorporated into the polymer backbone during the curing process thereby reducing or eliminating emission of volatile organic amines during or post cure.

According to certain embodiments, the present disclosure provides for a polymer and an aqueous polymer dispersion comprising a polyurethane comprising a copolymer main chain and having pendant polymerizable olefinic groups, such as, but not limited to, (meth)acryl groups, along the main chain and pendant non-ionic hydrophilic or ionic groups, such as, but not limited to, carboxylic acid groups, along the main chain; and a tertiary aminofunctional unsaturated monomer. As used herein the terms “(meth)acryl”, “(meth)acrylate”, and similar terms include acryl, methacryl, and other alkylacryl structures having substituted acryloyl functionality (i.e., R₂C═CR—C(═O)—, where each R may independently be —H or C₁-C₆ alkyl), such as, for example, (meth)acrylate and (meth)acrylamide. In various embodiments, the pendant non-ionic hydrophilic or ionic group may include other organic functional moieties having an acidic proton or ionic charge, such as, for example, sulfonic acid or sulfonate salts, sulfate groups, and phosphoric acid or phosphate groups. Acidic functionality may be neutralized to form an ionic pair prior to or during the dispersion of the polyurethane prepolymer in water by reaction with a tertiary amine, such as described herein.

According to various embodiments, the tertiary aminofunctional unsaturated monomer unit may have a structure according to Formula I:

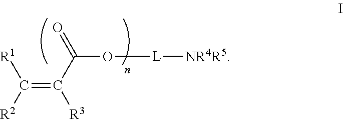

According to various embodiments, the tertiary aminofunctional unsaturated unit according to Formula I may be substituted with appropriate substituents at R¹-R⁵. Substitution on the olefin (i.e., R¹-R³) includes substituents such as —H and straight chain or branched C₁-C₁₀ alkyl. For example, R¹, R², and R³ may each independently be selected from —H and straight chain or branched C₁-C₁₀ alkyl. In specific embodiments, branches may include C₁-C₄ alkyl branches and C₁-C₄ alkoxy branches, as well as halogen substitution (i.e., —F, —Cl, —Br, or —I substitution). Substituents on the nitrogen of the tertiary aminofunctional unit (i.e., R⁴ and R⁵) may each independently be organic groups which have no reactivity towards the carbon-carbon double bond or the amine functionality. For example, suitable substituents for R⁴ and R⁵ include, but are not limited to, C₁-C₁₀ alkyl which may be substituted or unsubstituted, where the substitution include C₁-C₄ alkyl, C₁-C₄ alkoxy, and halogen.

Referring still to Formula I, “n” may have a value of 0 or 1 and L may be a divalent linking group. Non-limiting examples of divalent linking groups include, for example, a single bond, —(CH₂)ₘ—, —(CH₂CH₂O)ₘ—, —(CH₂CH(CH₃)O)ₘ—, —Ar—, and combinations of these linking groups, where “m” may range from 1 to 20 and Ar=aryl or heteroaryl. In specific embodiments, the divalent linking group may be selected from the group consisting of —CH₂—, —C₂H₄—, —C₃H₆—, —C₄H₈—, —C₅H₁₀—, —C₆H₁₂—, and —C₆H₄— (i.e., a disubstituted phenyl ring, wherein the substitution may be ortho, meta or para).

In certain embodiments, the tertiary aminofunctional unsaturated monomer may be selected from the group consisting of a triallyl amine, a alkyl diallyl amine, a dialkyl allyl amine, a dialkylaminoalkanol vinyl ether, a dialkylaminoalkyl acrylate, a dialkylaminoalkyl methacrylate, a dialkylaminoalkoxy acrylate, and a dialkylaminoalkoxy methacrylate, where the alkyl groups may be from C₁-C₁₀ alkyl. In specific embodiments, the tertiary aminofunctional unsaturated monomer may be selected from the group consisting of 2-(dimethylamino)ethyl acrylate, 2-(dimethylamino)ethyl methacrylate, 2-(diethylamino)ethyl acrylate, 2-(diethylamino)ethyl methacrylate, 2-(dimethylamino)ethanol vinyl ether, 2-(diethylamino)ethanol vinyl ether, and the like.

The polyurethanes of the present disclosure may comprise a main chain having pendant polymerizable olefinic groups, such as (meth)acryl groups, along the main chain and pendant non-ionic hydrophilic or ionic groups, such as carboxylic acid groups, along the main chain. As used herein, the term “polymerizable olefinic group” means a functional moiety that includes a carbon-carbon double bond that is reactive to addition polymerization conditions, such as free radical, ionic, or metal catalyzed addition polymerization conditions.

According to certain embodiments, the polyurethane comprises a reaction product of components comprising: a polyisocyanate monomer, a polyol or polyamine monomer, and monomeric, oligomeric, or polymeric units comprising hydroxy termini, amino termini, or a combination of hydroxy and amino termini. According to these embodiments, at least one of the polyisocyanate monomer, polyol monomer, and monomeric, oligomeric, or polymeric units comprises pendant non-ionic hydrophilic or ionic groups, such as the carboxylic acid groups; and at least one of the polyisocyanate monomer, polyol monomer, and monomeric, oligomeric, or polymeric units comprises pendant polymerizable olefinic groups, such as the (meth)acryl groups.

In certain embodiments, the polyisocyanate monomer may be a diisocyanate monomer. That is, the polyisocyanate monomer may be a monomer having an isocyanate moiety at each terminus of the compound. As discussed herein, in certain embodiments, the polyisocyanate monomer, such as the diisocyanate monomer, may have the pendant (meth)acrylate groups branching from the body of the monomer unit. In other embodiments, the polyisocyanate monomer, such as the diisocyanate monomer, may have the pendant carboxylic acid or carboxylate groups branching from the body of the monomer unit. In still other embodiments, the polyisocyanate monomer, such as the diisocyanate monomer, may comprise both the pendant (meth)acrylate groups and the carboxylic acid or carboxylate groups branching from the body of the monomer unit. Suitable polyisocyanate monomers include aliphatic araliphatic, and/or aromatic polyisocyanates, such as, but not limited to, butylene diisocyanate, isophorone diisocyanate, tetramethylene, diisocyanate, hexamethylene diisocyanate, trimethylhexamethylene diisocyanate (including 2,2,4- and 2,4,4-trimethylhexamethylene diisocyanate), di(isocyanatocyclohexyl)methane, isocyanatomethyl-1,8-octane diisocyanate, diphenylmethane diisocyanate, toluene diisocyanate, naphthylene diisocyanate, 4,4′-diphenyl ether diisocyanate, m-tetramethylxylene diisocyanate, dimers or trimers based on these isocyanate, or reaction products of these polyisocyanates with hydrogen-active compound, such as a polyhydric alcohol, a polyfunctional amine, or an amino alcohol.

In certain embodiments, the monomeric, oligomeric, or polymeric unit may be a polyol with one or more pendant (meth)acrylate group off polyol chain. In certain embodiments, the polyol with one or more pendant (meth)acrylate group may be a polyester diol. According to these embodiments, the polyester dial may have hydroxyl groups or other group that is reactive with an isocyanate moiety on the termini of the polyester chain. In still other embodiments, monomeric, oligomeric, or polymeric unit may be a polyester diol with one or more pendant (meth)acrylate group and one or more pendant carboxylic acid or carboxylate group off the polyester diol chain. In one specific embodiment, the residue of the monomeric, oligomeric, or polymeric unit may be polyester-acrylate diol. The polyester dial may be the reaction products of dicarboxylic acids and/or their anhydrides, ethylenically unsaturated dicarboxylic acids and/or their anhydrides, and lactones (such as, but not limited to, c-caprolactone) with one or more polyol or diol. Suitable polyols and/or dials may include aliphatic, cycloaliphatic or aromatic polyols and diols. Non-limiting examples of diols include ethylene glycol, the isomeric propanediols, butanediols, pentanediols, hexanediols, heptanediols, octanediols, and nonanediols, cyclohexanedimethanol, hydrogenated bisphenol-A, and derivatives of the above mentioned diols substituted with one or more C₁-C₆ alkyl groups. Other suitable diols include, for example, diols containing ester groups or ether groups, such as, (3-hydroxy-2,2-dimethylpropyl)-3-hydroxy-2,2-dimethyl propionate or diethylene glycol, dipropylene glycol, or tripropylene glycol. Further suitable diols include, neopentyl glycol, 2,2-dimethyl-1,3-propanediol, 2-ethyl-1,3-hexanediol, 2,5-dimethyl-1,6-hexanediol, 2,2,4-trimethyl-1,3-pentanediol, and 3-hydroxy-2,2-dimethylpropyl 3-hydroxy-2,2-dimethylpropionate. Suitable diols may also include diols in the form of their alkoxylation products (ethylene oxide, propylene oxide, and C₄-ether units).

In certain embodiments, the polyol with one or more pendant (meth)acrylate group may be a polyether diol. Suitable polyether diols are obtained in known manner by the reaction of starting compounds which contain reactive hydrogen atoms with alkylene oxides such as ethylene oxide; propylene oxide; butylene oxide; styrene oxide; tetrahydrofuran or epichlorohydrin or with mixtures of these alkylene oxides. It is preferred that the polyethers do not contain more than about 10% by weight of ethylene oxide units.

Suitable starting compounds containing reactive hydrogen atoms include, e.g. water and the dihydric alcohols set forth for preparing the polyester polyols.

According to various embodiments of the present disclosure the polyol monomer may be a diol monomer having one or more pendant carboxylic acid group. For example, the diol monomer may be 2,2-dimethylol alkanoic acid, for example, dimethylol propionic acid (2,2-bis(hydroxymethyl)propionic acid), 2,2-bis(hydroxymethyl)butyric acid, and the like. In certain embodiments, the pendant groups may be a derivative of a carboxylic group, such as an carboxylate anion, a carboxylic ester, a carboxylic anhydride, a cyanide moiety, or an amide group. Other embodiments of the polyurethane may comprise a polyol monomer that includes a diol monomer having one or more pendant anionic or hydrophilic group, such as those discussed in detail herein.

According to one specific embodiment, the polyurethane may comprise a reaction product of components comprising: a polyisocyanate monomer a monomeric, oligomeric, or polymeric unit comprising one or more pendant (meth)acrylate groups and having termini having groups reactive with isocyanate groups, a polyol monomer having one or more pendant carboxylic acid groups, and optionally a polyol or short chain dial. In a second specific embodiment, the polyurethane may comprise a diisocyanate monomer, a monomeric, oligomeric, or polymeric unit comprising one or more pendant (meth)acrylate group and having termini having groups reactive with isocyanate groups (such as hydroxyl groups), and a diol monomer having one or more pendant carboxylic acid groups.

According to certain embodiments, a general description of one approach to the synthetic process may include preparation of an isocyanate-terminated prepolymer. This prepolymer may be formed by reaction of a polyisocyanate, such as a diisocyanate; a polyester or polyether polyol comprising pendant (meth)acrylate groups, such as a polyester acrylate; and a diol having pendant carboxylic acid groups, such as dimethylol propionic acid. In specific embodiments, the prepolymer formation reaction may optionally comprise a polyester did, a polyether diol, a polycarbonate diol, or a short chain diol. The prepolymer formation reaction may also optionally comprise one or more of an organic solvent, an antioxidant or a catalyst. Prepolymer formation may be considered to be complete after the actual isocyanate concentration reaches or falls below its theoretical value. The theoretical value is a calculated value which represents the isocyanate content remaining when all the isocyanate reactive groups are reacted with isocyanate groups to form the prepolymer. This value indicates that the prepolymer reaction is complete. Next, the prepolymers may be chain extended by reaction of the isocyanate prepolymer termini with a short chain polyol, short chain diol, short chain polyamine, short chain diamine, or various mixtures of any thereof, to form a polyurethane polymer having pendant carboxylic acid groups off of the main chain and pendant (meth)acrylate groups off of the main chain. Formation of the polyurethane copolymer may be indicated by complete reaction of all the isocyanate groups, which is indicated by the disappearance of the peak corresponding to the isocyanate (—NCO) as shown by spectroscopic method (such as IR-spectroscopy).

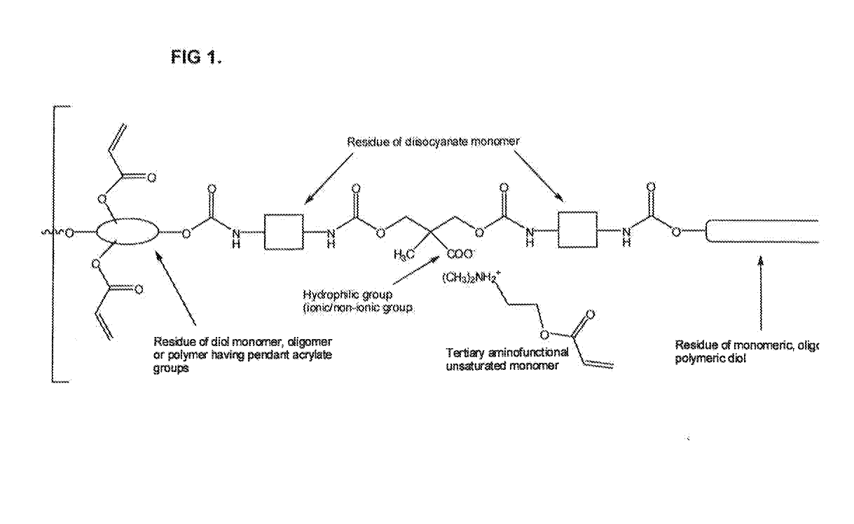

After formation of the polyurethane polymer, the tertiary aminofunctional unsaturated monomer, as described herein, may be added to the polymer mixture and the mixture is then dispersed in water or other aqueous solvent. The tertiary amine functionality neutralizes the pendant carboxylic acid groups along the main chain in an acid-base reaction to form a salt between the carboxylate anion and the ammonium cation. The organic solvent (if present) may then be removed, such as by distillation, to provide the aqueous polyurethane polymer dispersion or it may remain in the finished product. A generalized structure of one embodiment of a radiation curable polyurethane polymer dispersion according to the present disclosure is shown in FIG. 1.

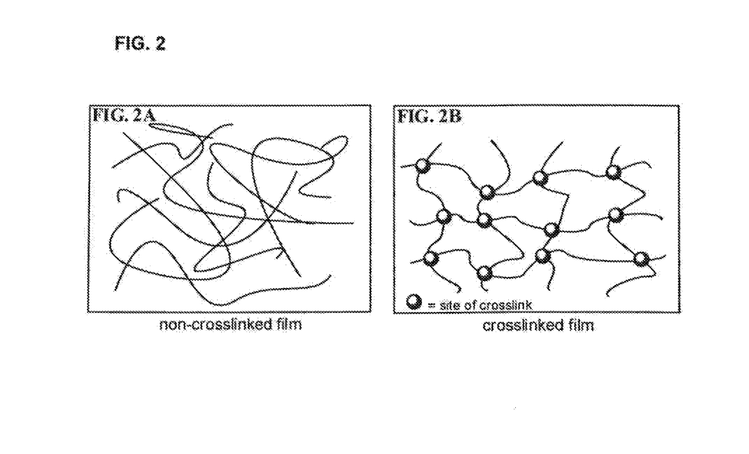

A film or coating may be formed from the aqueous polyurethane polymer dispersion by adding a photoinitiator to the dispersion and applying the resulting polyurethane dispersion to a surface of a substrate. The water may then be removed, for example, by flashing the water off and the resulting mixture comprising the polyurethane copolymer neutralized by the tertiary aminofunctional unsaturated monomer is treated with conditions to initiate an addition polymerization process. Suitable initiation conditions include, exposing the film to UV or EB radiation, heating the film, or other conditions known to initiate addition polymerization processes. The addition polymerization occurs between the carbon-carbon double bonds in the polyurethane copolymer. For example, the pendant (meth)acrylate groups on the copolymer main chain may polymerize with other pendant (meth)acrylate groups on an adjacent polymer chain. This can result in formation of crosslinks between the polymer chain in the film, such as, for example a “chain link fence” crosslinked polymer network as shown in FIG. 2.

In addition, a portion of the pendant (meth)acrylate groups may polymerize under the addition polymerization conditions with the carbon-carbon double bond of the tertiary aminofunctional unsaturated monomer. Via this mechanism, irradiating the film with radiation results in the tertiary aminofunctional unsaturated monomer units being incorporated into the polymer structure of the cured polyurethane film. Further, once the aminofunctional monomer units are incorporated into the polymer structure of the film, the emission of volatile amine compounds from the polymeric film is greatly reduced. As discussed above, one drawback of prior art polyurethane films formed from aqueous polymer dispersions is that the amine compound used to neutralize the carboxylic acid groups can volatilize and be emitted from the film (or article of manufacture having a coating of the polyurethane), resulting in environmental problems. The present disclosure provides a polyurethane film which will have significantly reduced emission of volatile organic amino compounds since the aminofunctional group used to neutralize the carboxylic acid will have no volatility once incorporated into the film or coatings polymeric structure.

According to one embodiment, the aqueous polymer dispersion comprising the polyurethane copolymer may be formed using the acetonic process. According to this process, the polymerization, for example, the polymerization to form the prepolymer and the polyurethane copolymer (by chain extension) as well as the neutralization of the pendant carboxylic acid groups with the tertiary aminofunctional unsaturated monomer is performed in an organic solvent, such as acetone or methyl ethyl ketone, and the polyurethane copolymer/tertiary aminofunctional unsaturated monomer acetone solution is dispersed in water to form the aqueous/organic solvent polymer dispersion. The organic solvent (e.g., acetone or methyl ethyl ketone) may then be removed to provide the aqueous polymer dispersion. According to another embodiment, the aqueous polymer dispersion comprising the polyurethane copolymer may be formed using the prepolymer process. According to this process, the prepolymer dissolved in an organic solvent is chain extended using a short chain polyol, short chain diol, short chain polyamine, short chain diamine, or various mixtures of any thereof; neutralized using the tertiary aminofunctional unsaturated monomer, and then dispersed in water to make an aqueous polyurethane copolymer. The chain extension, neutralization and dispersion steps may be performed in any order; for example the prepolymer dissolved in an organic solvent may be chain extended, neutralized and then dispersed in water, or the prepolymer dissolved in an organic solvent may be neutralized, dispersed in water and then chain extended, or the prepolymer dissolved in an organic solvent may be neutralized, chain extended and then dispersed in water, or the prepolymer dissolved in an organic solvent may be chain extended and then dispersed in a mixture of water and the tertiary aminofunctional unsaturated monomer.

According to the various embodiments of the aqueous dispersions described herein, the dispersion may further comprise at least one of a photoinitiator, (meth)acrylate monomers, an organic solvent, a solubilizing agent, an antioxidant, and a polymerization catalyst.

According to various embodiments, a photoinitiator may be added to the dispersion, for example, for the purpose of curing by high-energy radiation, such as, UV light. Suitable photoinitiators may include those known in the art, for example, photoinitiators described in “Chemistry & Technology of UV and EP Formulations for Coatings, Inks & Paints”, by P. K. T. Oldring (ed.), vol. 3, 1991, SITA Technology, London, pp. 61-325, the disclosure of which is incorporated by reference herein.

Suitable photo-initiators include, for example, aromatic ketone compounds such as benzophenones; alkylbenzophenones; 4,4′-bis(dimethylamino)benzo-phenone (Michler's ketone); anthrone; and halogenated benzophenones. Also suitable are acylphosphine oxides such as 2,4,6-trimethylbenzoyl-diphenylphosphine oxide; phenylglyoxylic ester; anthraquinone and its derivatives; benzil ketals; and hydroxyalkyl phenones.

Additional photo-initiators include 2,2-diethoxyacetophenone; 2- or 3- or 4-bromoacetophenone; 3- or 4-allyl-acetophenone; 2-acetonaphthone; benzaldehyde; benzoin; the alkyl benzoin ethers; benzophenone; benzoquinone; 1-chloroanthra-quinone; p-diacetyl-benzene; 9,10-dibromoanthracene 9,10-dichloroanthracene; 4,4-dichlorobenzophenone; thioxanthone; isopropyl-thioxanthone; methylthioxanthone; α,α,α-trichloro-para-t-butyl acetophenone; 4-methoxybenzophenone; 3-chloro-8-nonylxanthone; 3-iodo-7-methoxyxanthone; carbazole; 4-chloro-4′-benzylbenzophenone; fluoroene; fluoroenone; 1,4-naphthylphenylketone; 1,3-pentanedione; 2,2-di-sec-butoxy acetophenone; dimethoxyphenyl acetophenone; propiophenone; isopropylthioxanthone; chlorothioxanthone; xanthone; and mixtures thereof.

There are also several suitable photo-initiators commercially available including Irgacure® 184 (1-hydroxy-cyclohexyl-phenyl-ketone); Irgacure® 500 (a 1:1 by weight mixture of benzophenone and 1-hydroxy-cyclohexyl-phenyl-ketone); Irgacure® 819 (bis(2,4,6-trimethylbenzoyl)-phenylphosphineoxide); Irgacure® 1850 (a 1:1 by weight mixture of bis(2,6-dimethoxybenzoyl)-2,4,4-trimethylpentyl-phosphine oxide and 1-hydroxy-cyclohexyl-phenyl-ketone); Irgacure® 1700 (a 25/75 mixture of bis(2,6-dimethoxybenzoyl)-2,4,4-trimethylpentyl-phosphine oxide and 2-hydroxy-2-methyl-1-phenyl-propan-1-one); Irgacure® 907 (2-methyl-1[4-(methylthio)phenyl]-2-morpholono-propan-1-one); Darocur® MBF (a phenyl glyoxylic acid methyl ester); and Darocur® 4265 (a 50/50 mixture of bis(2,4,6-trimethylbenzoyl)-phenylphosphineoxide and 2-hydroxy-2-methyl-1-phenyl-propan-1-one).

The photoinitiators may be used alone or in combination with one or more other photoinitiator, and optionally together with further accelerators or co-initiators as additives. In certain embodiments, the photoinitiators may be used in amounts of 0.01 to 10 parts by weight, in certain embodiments from 0.5 to 5 parts by weight, and in other embodiments in from 1 to 3 parts by weight, based on solids in a coating composition.

In various embodiments, the dispersion may also comprise an antioxidant. Suitable antioxidants may include, for example, BHT (butylated hydroxytoluene) and BHA (butylated hydroxyanisole), phenols, cresols, hydroquinone and quinones (such as 2,5-di-tert-butylquinone). Other suitable antioxidant additives are described, for example, in “Methoden der organishen Chemie (“Methods of organic chemistry”)(Houben-Weyl), 4th ed. vol. XIV/1, page 433 ff, Georg Thieme Verlag, Stuttgart, 1961, the disclosure of which is incorporated by reference herein. Such antioxidants may serve to stabilize the free isocyanate groups in the prepolymer against premature polymerization. The antioxidants may be added in amounts of 0.001 to 0.3 percent by weight, either during or following preparation of the polyurethane polyacrylate.

According to various embodiments, the dispersion may comprise an organic solvent. Suitable solvents include solvents that are inert with respect to isocyanate groups and carbon-carbon double bonds. Suitable solvents may include, but are not limited to, acetone, methyl ethyl ketone, N-methylpyrrolidone (NMP), ethyl acetate, butylacetate, ethylene glycol monomethyl or monoethyl ether acetate, 1-methoxypropyl 2-acetate, 3-methoxy-n-butyl acetate, 4-methyl-2-pentanone, cyclohexanone, toluene, xylene, chlorobenzene, mixtures known as solvent naphtha, carbonic esters such as dimethyl carbonate, diethyl carbonate, 1,2-ethylene carbonate and 1,2-propylene carbonate, propylene glycol diacetate, diethylene glycol dimethyl ether, dipropylene glycol dimethyl ether, diethylene glycol ethyl and butyl ether acetate, and N-methylcaprolactam or any desired mixtures of such solvents. For example, in certain embodiments a volatile ketone solvent (such as acetone) may be used in the acetonic process to produce the dispersion. In other embodiments, a solvent (such as NMP) may be used in the prepolymer process to produce the dispersion.

In certain embodiments, the dispersion may comprise a one or more polymerization catalysts. Suitable polymerization catalysts include those known in the art, such as, tin octanoate, dibutyltin dilaurate (DBTL), dibutyltin oxide, and tertiary amine catalysts, such as 1,4-diazabicyclo[2.2.2]octane (DABCO), dimethylcyclohexylamine, and dimethylethanolamine.

Other embodiments of the present disclosure provide a radiation cured polyurethane comprising a reaction product of components comprising: a polyisocyanate monomer; a polyol monomer having a pendant carboxylate ion; a monomeric, oligomeric, or polymeric polyol having residues of pendant (meth)acrylate groups; and a tertiary aminofunctional unsaturated monomer. According to these embodiments, the tertiary amine group of the tertiary aminofunctional unsaturated monomer has formed an ionic pair with a pendant carboxylate ion, and the unsaturated group on the tertiary aminofunctional unsaturated monomer has reacted with a pendant (meth)acrylate group during a radiation curing process. In certain embodiments, the tertiary aminofunctional unsaturated monomer may have a structure according to Formula I, as set forth herein.

The radiation cured polyurethane according to various embodiments may further comprise a reaction product of components comprising a dial selected from the group consisting of a polyester diol, a polyether diol, a polycarbonate diol, a short chain alkyl diol, and combinations of any thereof. Examples of such diol residues are described in detail herein.

In certain embodiments, the radiation cured polyurethane may be in the form of a film. For example, the radiation cured polyurethane may be a film on at least a portion of a surface of a substrate, such as, but not limited to, automobile components. Films formed from the radiation cured copolymers of the various embodiments may have a dry film thickness ranging from about 1 μm to about 100 μm and in other embodiments from about 30 μm to about 70 μm. Such films may provide a coating on the surface and may demonstrate improved performance over conventional polyurethane coating films.

Further embodiments of the present disclosure are directed toward processes for forming an aqueous polyurethane copolymer dispersion. The processes may comprise the steps of preparing a prepolymer comprising a polyurethane, wherein the polyurethane comprises a main chain and having pendant (meth)acrylate groups along the copolymer main chain and pendant carboxylic acid groups along the copolymer main chain; neutralizing the pendant carboxylic acid groups along the copolymer main chain with a tertiary aminofunctional unsaturated monomer; and dispersing the prepolymer in an aqueous solution. According to various embodiment, the tertiary aminofunctional unsaturated monomer may have a structure according to Formula I, as described in detail herein.

In certain embodiments, the polyurethane may be any of the polyurethanes set forth herein. For example, in one embodiment, the polyurethane may comprise a reaction product of components comprising a polyisocyanate monomer, a polyol monomer, and a monomeric, oligomeric, or polymeric unit comprising hydroxy termini or amino termini. According to this embodiment, at least one of the polyisocyanate monomer, the polyol monomer, and the monomeric, oligomeric, or polymeric unit may comprise the pendant carboxylic group and at least one of the polyisocyanate monomer, the polyol monomer, and the monomeric, oligomeric, or polymeric unit may comprise the pendant (meth)acrylate groups. Other embodiments of the polyurethanes are described in detail herein.

Still other embodiments of the present disclosure are directed toward processes for forming a radiation cured polyurethane. According to these embodiments, the process may comprise preparing a prepolymer comprising: (a) applying a coating to at least a portion of a surface of a substrate to form a film; and (b) exposing the film to ultra-violet or electron beam radiation, wherein the coating comprises an aqueous polyurethane dispersion formed by a process comprising: (i) preparing a prepolymer comprising a polyurethane comprising a main chain and having pendant (meth)acrylate groups along the main chain and pendant carboxylic acid groups along the main chain, wherein the prepolymer is optionally in solvent; (ii) neutralizing the pendant carboxylic acid groups along the main chain with a tertiary aminofunctional unsaturated monomer; and (iii) dispersing the prepolymer in an aqueous solution to form a dispersion.

Suitable substrates (monomers etc.) for forming the polyurethane of the prepolymer are described in detail herein. Further, according to specific embodiments, the tertiary aminofunctional unsaturated monomer may have a structure according to Formula I, as described herein.

In specific embodiments, the prepolymer may further comprise a solvent, such as, for example, water, acetone, methyl ethyl ketone, NMP, and mixtures of any thereof. For example, in one embodiment of the process, the process may be performed using the acetonic process wherein the solvent is acetone, methyl ethyl ketone, or mixtures thereof. In another embodiment of the process, the process may be performed using the NMP process wherein the solvent is NMP. According to certain embodiments of the process, the process may further comprise heating the film or coating of the prepolymer dispersion to remove at least one of the solvent and water. For example, in the acetonic process, heating may be used to remove (for example, by evaporation) the acetone and/or methyl ethyl ketone solvent; and in the NMP process, heating may be used to remove the NMP solvent. Further, in specific embodiments heating may be used to remove water from the dispersion. Heating according to these embodiments may include heating the film or coating to a temperature ranging from about 25° C. to about 90° C. for a time sufficient to remove the water.

Applying the coating of the dispersion to at least a portion of a surface of the substrate may include spraying the dispersion on the surface of the substrate, for example using conventional spray techniques. Other processes for applying the coating may include submerging the surface of the substrate into the dispersion, brush and roll application, reverse roll coating, roto-gravuere coating, knife coating. After exposure of the film to radiation, such as UV radiation, the cured film of the various embodiments may have a dry film thickness ranging from about 1 μm to about 100 μm and in other embodiments from about 30 μm to about 70 μm. Suitable substrates include, for example, any substrate on which a polyurethane copolymer film may be applied, for example various automotive substrates.

The present disclosure also provides for coating or films of the radiation cured polyurethane made by any of the processes described herein. For example, in certain embodiments, the coating or film of the radiation cured polyurethane may include a cross linked structure having cross links formed between the pendant (meth)acrylate groups on the main chain and other (meth)acrylate groups in the structure or between the pendant (meth)acrylate groups on the main chain and the unsaturated groups on the tertiary aminofunctional unsaturated monomer. According to certain embodiments, the prepolymer formed by the various processes described herein may have a structure as illustrated in FIG. 1. Referring to FIG. 2, the film formed from the dispersion may have a polymeric structure as depicted in FIG. 2A prior to cross linking by exposure to UV curing and a cross linked structure as depicted in FIG. 2B after exposure to UV curing.

According to other embodiments, the present disclosure provides for coating compositions, such as coating compositions comprising aqueous polymer dispersions according to the various embodiments described herein. For example, in one embodiment, the coating composition may comprise a polyurethane copolymer comprising a main chain and having pendant (meth)acrylate groups along the copolymer main chain and pendant carboxylic acid groups along the main chain; and also comprising a tertiary aminofunctional unsaturated monomer, as described herein, for example a monomer having the structure according to Formula I. One exemplary embodiment of the coating composition, prior to curing, is illustrated in FIG. 1.

Further, according to various embodiments, the present disclosure provides for coatings and films comprising a radiation cured polyurethane having a structure as described herein. For example the radiation cured polyurethane may have a structure that is the reaction product of components comprising a polyisocyanate monomer; a polyol monomer having a pendant carboxylate ion; a monomeric, oligomeric or polymeric polyol unit having pendant (meth)acrylate groups; and a tertiary aminofunctional unsaturated monomer. Various examples of suitable structures for each of these components are set forth in detail herein. According to these embodiments, the tertiary amine has formed an ionic pair with a pendant carboxylate ion on the polymer main chain. Further, the unsaturated group on the tertiary aminofunctional unsaturated monomer has reacted with a pendant (meth)acrylate group during the radiation curing process. As previously discussed, the tertiary aminofunctional unsaturated monomer may assist in the solubility of the prepolymer by forming the ionic bond with the carboxylate or carboxylic acid group on the main chain of the polyurethane and because the tertiary aminofunctional unsaturated monomer also reacts with a pendant (meth)acrylate group on the polymer main chain, the volatility of the tertiary amino neutralizing group is significantly reduced. For example, using conventional tertiary amine neutralizing agents to form films from polyurethane dispersions results in the undesired release of volatile amines during curing and post-curing. However, according the present disclosure, the tertiary amine neutralizing agent is incorporated into the polymer and will display essentially no volatility during or post-curing.

The various embodiments of the compositions and processes described herein may be better understood when read in conjunction with the following non-limiting examples.

### EXAMPLES

### Example 1

An anionic polyurethane-polyacrylate dispersion was prepared by introducing 42.8 g (0.0428 eqs) of Arcol PPG 2000 polypropylene glycol available from Bayer MaterialScience AG, 22.5 g (0.0440 eqs) of a polyester-acrylate diol, Desmophen® 1602, available from Bayer MaterialScience AG, 5.0 g (0.0022 eqs) of a mono-functional polyether, Polyether LB-25, from Bayer MaterialScience AG, 4.7 g (0.0700 eqs) of dimethylol propionic acid from GEO, 1000 ppm of BHT (2,6-di-tert-butyl-4-methylphenol from Aldrich) stabilizing agent and 47.5 g of NMP (n-methyl-2-pyrrolidone) solvent into a 2 L glass flask equipped with a thermocouple-controlled heating mantel, a condenser and a stirring blade. The flask was heated to 60 C. The content of the flask was allowed to mix well before addition of 35.6 g (0.3200 eqs) of Desmodur® I (isophorone diisocyanate from Bayer MaterialScience AG) and 0.11 g of Dabco® T-12 catalyst (tin catalyst from Air Products& Chemicals). The reaction exothermed to 80° C. and was allowed to continue for 4 hours at 80° C. and left overnight at room temperature in order to get the % NCO at or below theoretical value of 4.25%. The reaction was resumed the next morning. The resultant prepolymer was analyzed and found to have an NCO concentration of 4.36%. A mixture of 6.0 g of NMP and 6.0 g (0.1920 eqs) of ethylene glycol (from Aldrich) were added to the flask and mixed until the disappearance of NCO peak in FT-IR, which indicated completion of the polymer formation. Then, 7.5 g (0.0525 eqs) of 2-(Dimethylamino)ethyl acrylate neutralizing agent from Aldrich was added to the mixture and mixed for 1 hour at 80 C. The prepared polymer solution was dispersed in a mixture of 177.3 g of distilled water and 1.4 g of Surfynol® 104H (surfactant from Air Products & Chemicals).

The product, a polyurethane-polyacrylate dispersion, was stirred for 1 hour, filtered through 50 micron bag and stored in a plastic bottle.

The dispersion had 31.4% solids (Mettler Hr73), pH of 8.0, viscosity of 60 cps at 25 C (Brookfield viscometer RVT, spindle #3, 100 rpm), and mean particle size was 0.175 micron (Horiba Particle Size Analyzer).

### Example 2

An anionic polyurethane-polyacrylate dispersion was prepared by introducing 74.85 g (0.15 eqs) of a polyester-acrylate diol, Desmophen® 1602, available from Bayer MaterialScience AG, 6.75 g (0.003 eqs) of a mono-functional polyether, Polyether LB-25, available from Bayer MaterialScience AG, 8.57 g (0.13 eqs) of dimethylolpropionic acid from GEO, and 1000 ppm of BHT (2,6-di-tert-butyl-4-methylphenol from Aldrich) stabilizing agent into 2 L glass flask equipped with a thermocouple-controlled heating mantel, a condenser and a stirring blade. The flask content was heated to 70 C. The content of the flask was allowed to mix well before addition of 55.95 g (0.50 eqs) of Desmodur® I (isophorone diisocyanate from Bayer MaterialScience AG) and 0.03g of Dabco® T-12 catalyst (tin catalyst from Air Products & Chemicals). The reaction exothermed to 87° C., cooled to 80° C., and was allowed to continue cooking for approximately 4 hours at 80° C. The resultant prepolymer was analyzed and found to have an NCO concentration of 5.76% which was below the theoretical value of 6.42%. Next, 7.51 g (0.24 eqs) of ethylene glycol from Aldrich were added to the flask and mixed well. The reaction contents exothermed to 87° C. 21.0 g of acetone (from Fischer Scientific) was added to the flask to reduce prepolymer viscosity. The temperature decreased to 72° C. The reaction continued at 70° C. until the end of the day and then was cooled down for the night since FTIR showed presence of the isocyanate groups and the goal is to react until all NCO groups are consumed. The reaction was resumed the next morning by heating the flask to 80° C. and allowing it to cook for 2.5 hours at 80° C. 48.7 g of acetone were added to reduce viscosity of the prepolymer, temperature dropped to 65° C. The reaction continued for another 3 hours at 70° C. until the disappearance of NCO peak by FT-IR, which indicated completion of the polymer formation. Then, 15.0 g (0.1 eqs) g of 2-(Dimethylamino)ethyl methacrylate (from Aldrich) neutralizing agent was added to the mixture and mixed for 45 minutes at 60° C. The reaction was cooled down to 40° C. and the polymer solution was dispersed by addition of 300 g of DI water into the flask under high agitation over 20 min. Acetone distillation started immediately after completing the dispersing step. Acetone was removed at 120 mbar within 1 hour.

The product, polyurethane-polyacrylate dispersion, was stirred for 1 hour, filtered through 50 micron bag and stored in a plastic bottle.

The dispersion had 24.4% solids (Mettler Hr73), pH of 6.8, viscosity of 115 cps at 25 C (Brookfield viscometer RVT, spindle #3, 100 rpm), and mean particle size was 0.557 micron (Horiba Particle Size Analyzer).

### Example 3

An anionic polyurethane-polyacrylate dispersion was prepared by introducing 54.6 g (0.08 eqs) of a polyester-acrylate diol, Laromer® PE 44F from BASF, 5.64 g (0.003 eqs) of a mono-functional polyether, Polyether LB-25, from Bayer MaterialScience AG, 6.76 g (0.10 eqs) of dimethylolpropionic acid from GEO, and 1000 ppm of BHT (from Aldrich) stabilizing agent into a 2 L glass flask equipped with a thermocouple-controlled heating mantel, a condenser and a stirring blade. The flask content was heated to 70° C. The content of the flask was allowed to mix well before addition of 28.21 g (0.25 eqs) of Desmodur® I (isophorone diisocyanate from Bayer MaterialScience AG). The reaction exothermed to 83° C., excess temperature over 80° C. was avoided. The reaction was cooled to 80° C. and became very viscous. 23.9 g of acetone (from Fischer Scientific) was added to control viscosity, along with 0.03 g of Dabco® T-12 catalyst. The temperature was set to 65° C. and was allowed to cook for approximately 1.5 hours at 65° C. The resultant prepolymer was analyzed and found to have an NCO concentration of 2.10% which was below the theoretical value of 3.20%. The heat was set to 40° C. and 152.4 g of acetone was slowly added. The reaction was maintained at 40° C. and the chain extenders were added drop wise (a mixture of 5.65 g of DPA-DEG (diethylene glycol bis(3-aminopropyl)ether) 97% (from Aldrich) and 0.85 g DEA (diethylamine from Aldrich) in 18.5 g of H₂O). After complete addition of the chain extenders the reaction was allowed to cook at 40° C. for 1 hour. After 1 hour a sample was taken for the presence of NCO, FT-IR showed no presence of the isocyanate groups. Then, 7.92 g (0.05 eqs) of 2-(Dimethylamino)ethyl methacrylate (from Aldrich) neutralizing agent was added to the mixture and mixed for 30 minutes at 40° C. The reaction was maintained at 40° C. and the polymer solution was dispersed by addition of 188.8 g of DI water into the flask under high agitation over 20 min. Acetone distillation started immediately after completing the dispersing step. Acetone was removed at 120 mbar within 1 hour.

The product, polyurethane-polyacrylate dispersion, was stirred for 1 hour, filtered through 50 micron bag and stored in a plastic bottle.

The dispersion had 33.55% solids (Mettler Hr73), and mean particle size was 1.705 micron (Horiba Particle Size Analyzer).

### Example 4

An anionic polyurethane-polyacrylate dispersion was prepared by introducing 66.15 g (0.09 eqs) of a polyester-acrylate diol, Laromer® PE 44F from BASF, 4.85 g (0.003 eqs) of a mono-functional polyether, Polyether LB 25, from Bayer MaterialScience AG, 6.32 g (0.10 eqs) of dimethylolpropionic acid (from CEO), and 1000 ppm of BHT stabilizing agent (from Aldrich) into 2 L glass flask equipped with a thermocouple-controlled heating mantel, a condenser and a stirring blade. The flask contents were heated to 60° C. The content of the flask was allowed to mix well at 60° C. before the addition of 27.68 g (0.25 eqs) of Desmodur® I (isophorone diisocyanate from Bayer MaterialScience AG). The reaction exothermed to 75° C., excess temperature over 75° C. was avoided. The temperature was set to 75° C. and was allowed to cook for approximately 1.5 hours at 75° C. The resultant prepolymer was analyzed and found to have an NCO concentration of 2.65% which was slightly above the theoretical value of 2.32%. The heat was set to 40° C. and 158.0 of acetone (from Fischer Scientific) was slowly added. The reaction was maintained at 40° C. and the chain extender was added drop wise (1.12 g of Ethylenediamine (from Aldrich) in 5.14 g of H2O). After complete addition of the chain extender, the reaction was allowed to cook at 40° C. for 1 hour. After 1 hour 14.83 g (0.09 eqs) of 2-(Dimethylamino)ethyl methacrylate (from Aldrich) neutralizing agent was added to the mixture and mixed for 30 minutes at 40° C. The reaction was maintained at 40° C. and the polymer solution was dispersed by the addition of 240.7 g of DI water into the flask under high agitation over 20 min. Acetone distillation started immediately after completing the dispersing step. Acetone was removed at 120 mbar within 1 hour. The resulting dispersion is very viscous and enough H₂O was added to reduce the percent solids to approximately 30%.

The product, polyurethane-polyacrylate dispersion, was stirred for 1 hour, filtered through 50 micron bag and stored in a plastic bottle.

The dispersion had 27.97% final solids (Mettler Hr73), and a mean particle size of 0.076 micron (Horiba Particle Size Analyzer).

What is claimed is:

1. An aqueous polymer dispersion comprising:
a polyurethane prepolymer comprising a main chain and having pendant (meth)acrylate groups along the main chain and pendant carboxylic acid groups along the main chain; and
a tertiary aminofunctional unsaturated monomer having a structure according to Formula I: 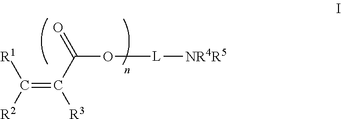
wherein, R¹, R², and R³ are each independently H or straight or branched, substituted or unsubstituted, C₁-C₁₀ alkyl, R⁴ and R⁵ are each independently organic groups which have no reactivity towards the carbon-carbon double bond or the amine functionality, n has a value of 0 or 1, and L is a divalent organic linking group.

2. The dispersion of claim 1, wherein the polyurethane prepolymer comprises a reaction product of components comprising: a polyisocyanate monomer; a polyol monomer; and a monomeric, oligomeric, or polymeric unit comprising hydroxy termini or amino termini,
wherein at least one of the polyisocyanate monomer, the polyol monomer, and the monomeric, oligomeric, or polymeric unit comprises the pendant carboxylic acid groups, and
at least one of the polyisocyanate monomer, the polyol monomer, and the monomeric, oligomeric, or polymeric unit comprises the pendant (meth)acrylate groups.

3. The dispersion of claim 2, wherein the polyisocyanate monomer is a diisocyanate monomer.

4. The dispersion of claim 2, wherein the monomeric, oligomeric, or polymeric unit is a polyester diol with pendant (meth)acrylate groups.

5. The dispersion of claim 2, wherein the polyol monomer is a diol monomer having a pendant carboxylic acid group.

6. The dispersion of claim 2, wherein the polyurethane prepolymer comprising a reaction product of components further comprising a diol selected from the group consisting of a polyester diol, a polyether diol, a polycarbonate diol, a short chain alkyl diol, and combinations of any thereof.

7. The dispersion of claim 1, wherein the tertiary aminofunctional unsaturated monomer is selected from the group consisting of triallyl amine, a dialkylaminoalkyl acrylate, a dialkylaminoalkyl methacrylate, a dialkylaminoalkoxy acrylate, and a dialkylaminoalkoxy methacrylate.

8. The dispersion of claim 7, wherein the tertiary aminofunctional unsaturated monomer is selected from the group consisting of 2-(dimethylamino)ethyl acrylate, 2-(dimethylamino)ethyl methacrylate, 2-(diethylamino)ethyl acrylate, and 2-(diethylamino)ethyl methacrylate.

9. The dispersion of claim 1, wherein L is a divalent linking group selected from the group consisting of —CH₂—, —C₂H₄—, —C₃H₆—, —C₅H₁₀—, —C₆H₁₂— and —C₆H₄—.

10. The dispersion of claim 1, further comprising at least one of a photoinitiator, (meth)acrylate monomers, an organic solvent, a solubilizing agent, an antioxidant, and a polymerization catalyst.

11. A radiation cured polymer comprising a reaction product of components comprising:
a polyisocyanate monomer;
a polyol monomer having a pendant carboxylic acid or carboxylate ion;
a monomeric, oligomeric, or polymeric polyol unit having pendant (meth)acrylate groups; and
a tertiary aminofunctional unsaturated monomer,
wherein a tertiary amine has formed an ionic pair with a pendant carboxylate ion and an unsaturated group on the tertiary aminofunctional unsaturated monomer has reacted with a pendant (meth)acrylate group during a radiation curing process.

12. The polymer of claim 11, wherein the tertiary aminofunctional unsaturated monomer has a structure according to Formula I: 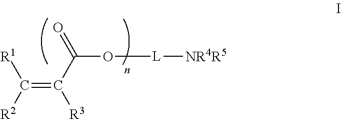
wherein, R¹, R², and R³ are each independentlyH or straight or branched, substituted or unsubstituted, C₁-C₁₀ alkyl, R⁴ and R⁵ are each independently organic groups which have no reactivity towards the carbon-carbon double bond or the amine functionality, n has a value of 0 or 1, and L is a divalent organic linking group.

13. The polymer of claim 11, wherein the polymer comprises a reaction product of components further comprising a diol selected from the group consisting of a polyester diol, a polyether diol, a polycarbonate diol, a short chain alkyl diol, and combinations of any thereof.

14. The polymer of claim 11, wherein the radiation cured polymer is in the form of a film.

15. A process for forming an aqueous polyurethane dispersion comprising:
preparing a prepolymer comprising a polyurethane comprising a main chain and having pendant (meth)acrylate groups along the main chain and pendant carboxylic acid groups along the main chain;
neutralizing the pendant carboxylic acid groups along the main chain with a tertiary aminofunctional unsaturated monomer; and
dispersing the prepolymer in an aqueous solution.

16. The process of claim 15, wherein the polyurethane comprises a reaction product of components comprising:
a polyisocyanate monomer; a polyol monomer; and a monomeric, oligomeric, or polymeric unit comprising hydroxy termini or amino termini,
wherein at least one of the polyisocyanate monomer, the polyol monomer, and the monomeric, oligomeric, or polymeric unit comprises the pendant carboxylic acid groups, and
at least one of the polyisocyanate monomer, the polyol monomer, and the monomeric, oligomeric, or polymeric unit comprises the pendant (meth)acrylate groups.

17. A process for forming a radiation cured polyurethane film comprising:
(a) applying a coating to at least a portion of a surface of a substrate to form a film; and
(b) exposing the film to ultra-violet or electron beam radiation, wherein the coating comprises an aqueous polyurethane dispersion formed by a process comprising:
(i) preparing a prepolymer comprising a polyurethane comprising a main chain and having pendant (meth)acrylate groups along the main chain and pendant carboxylic acid groups along the main chain, wherein the prepolymer is optionally in solvent;
(ii) neutralizing the pendant carboxylic acid groups along the main chain with a tertiary aminofunctional unsaturated monomer; and
(iii) dispersing the prepolymer in an aqueous solution to form a dispersion.

18. The process of claim 17, wherein the solvent is selected from the group consisting of water, acetone, N-methyl pyrrolidinone and mixtures of any thereof.

19. The process of claim 17, further comprising heating the coating of the to remove at least one of the solvent and water.

20. A coating made by the process according to claim 17.

21. A coating composition comprising aqueous polymer dispersion comprising
a polyurethane comprising a main chain and having pendant (meth)acryl groups along the main chain and pendant carboxylic acid groups along the main chain; and
a tertiary aminofunctional unsaturated monomer having a structure according to Formula I: 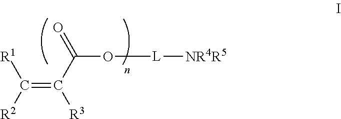
wherein, R¹, R², and R³ are each independently —H or C₁-C₁₀ alkyl, R⁴ and R⁵ are each independently organic groups which have no reactivity towards the carbon-carbon double bond or the amine functionality, n has a value of 0 or 1, and L is a divalent organic linking group.

22. A coating comprising a radiation cured polyurethane comprising a reaction product of components comprising:
a polyisocyanate monomer;
a polyol monomer having a pendant carboxylic acid or carboxylate ion;
a monomeric, oligomeric, or polymeric polyol unit having residues of pendant (meth)acrylate groups; and
a tertiary aminofunctional unsaturated monomer,
wherein a tertiary amine has formed an ionic pair with a pendant carboxylate ion and an unsaturated group on the tertiary aminofunctional unsaturated monomer has reacted with a pendant (meth)acrylate group during a radiation curing process.
